(19) United States
(12) Patent Application Publication
(10) Pub. No.: US 2016/0203681 A1
(43) Pub. Date: Jul. 14, 2016

(54) WIRELESS DATA MONITORING AND OPERATIONAL CONTROL FOR A WORK RIG

(71) Applicants: Barry J. Nield, Jacksonville Beach, FL (US); George A. Nield, Jacksonville Beach, FL (US)

(72) Inventors: Barry J. Nield, Jacksonville Beach, FL (US); George A. Nield, Jacksonville Beach, FL (US)

(21) Appl. No.: 14/947,327

(22) Filed: Nov. 20, 2015

Related U.S. Application Data
(60) Provisional application No. 62/102,269, filed on Jan. 12, 2015.

(51) Int. Cl. G08B 5/22; E21B 41/00

(52) U.S. Cl. CPC G08B 5/225; E21B 41/00

(57) ABSTRACT

A system for communicating with a drill rig includes a data management system on the drill rig configured to receive data reflective of an operating parameter of the drill rig. A communications device is operably coupled to the data management system and configured to transmit the data, and a local computing device is configured to receive the data. A graphical user interface on the local computing device is configured to display the data. A method for communicating with a drill rig includes receiving the data, transmitting a request for accessing the data, and transmitting the data. The method further includes transmitting from the local computing device to the data management system an instruction to control equipment on the drill rig.

### CROSS REFERENCE TO RELATED APPLICATION

This application claims the filing benefit if U.S. Provisional Patent Application Ser. No. 62/102,269 having a filing date of Jan. 12, 2015, which is incorporated herein in its entirety.

### FIELD OF INVENTION

The present subject matter relates generally to a system and method for providing wireless communications to and from a computer-based system positioned on or within a work rig and, more particularly, to a system and method that allows for wireless data monitoring and/or wireless operational control of a work rig.

### BACKGROUND OF THE INVENTION

Work rigs, such as drilling rigs and well work over rigs are well known in the oil and gas industry. For example, drilling rigs are commonly used in oil and gas production and well service operations and include heavy duty machinery to bore substantial distances below the earth's surface. The drilling rigs are often located in remote locations, and the heavy duty machinery is expensive to maintain and can cause significant personnel and equipment damage in a short period of time. In addition, changes in environmental conditions and/or the location of the drilling rig may adversely affect operations and maintenance of the heavy duty machinery. As a result, local personnel are often required to monitor the operations, identify operating trends and/or imminent events, and take appropriate actions to prevent or mitigate personnel and/or equipment damage.

Accordingly, a system and method that provides local personnel with the ability to wirelessly monitor the operation of a work rig and/or wirelessly control aspects of the operation of the work rig would be useful.

### BRIEF DESCRIPTION OF THE INVENTION

Aspects and advantages of the invention will be set forth in part in the following description, or may be obvious from the description, or may be learned through practice of the invention.

In general, the present subject matter is directed to a system and method for communicating with an onboard computer-based system of a given work rig, such as a drilling rig, a well work-over rig and/or any other suitable rig (e.g., any rig typically utilized within the oil and gas industry). In several embodiments, the system may include one or more sensors configured to monitor various operating parameters associated with the work rig and any of its auxiliary and/or related equipment (e.g., including, but not limited to, mud pumps, power generation equipment and/or the like) and generate data reflective of such parameters (e.g., in the form of sensor measurement signals). For instance, the data may include temperature, pressure, speed, depth, weight, volume and other operating parameters associated with the various equipment on the work rig and/or other information associated with the work rig, such as weather conditions, weather forecasts, the location of the work rig, and the attitude (e.g., pitch and yaw) of the work rig, etc. The sensors may generally be configured to transmit or otherwise communicate the data to a computer-based, data management system located on or within the work rig, which may be configured to temporarily and/or permanently store the data. Additionally, as will be described in greater detail below, the data management system may include and/or may otherwise be communicatively coupled to a communications device that allows the data received from the sensors to be transmitted wirelessly (or, optionally, via a wired connection) to one or more local computing devices, such as one or more smartphones, tablets and/or other portable/mobile computing devices carried within the vicinity of the work rig by local personnel. In such embodiments, each local computing device may be configured to display a suitable interface to the user of such device that allows the user to view the various monitored operating parameters for the work rig. For example, specific software may be installed onto the local computing device(s) (e.g., in the form a custom application) that provides for the display of a graphical user interface (GUI) for viewing the various operational parameters of the work rig in real time.

Moreover, the connection provided between the data management system and the local computing device(s) may also allow the user of the local device(s) to transmit suitable instructions, requests and/or other data back to the data management system. For instance, the GUI displayed on the user's device may allow the user to set operating limits for one or more of the monitored operating parameters and/or provide control commands for performing any other suitable control action related to the operation of the work rig, such as by transmitting instructions to perform a calibration of one or more of the sensors and/or other equipment associated with the work rig.

In addition to providing wireless access to the operational data for the work rig, the data management system may also be configured to transmit automatic notifications and/or alerts to the local computing device(s) positioned within the wireless transmission range of the data management system. For example, the data management system may be configured to wirelessly transmit email alerts, text alerts and/or other suitable alerts to the local computing device(s) based on the current operation of the work rig, such as when one of the monitored operating parameters exceeds a pre-defined operational limit(s) set for such parameter(s). Specifically, in one embodiment, a user may be allowed to define specific alert conditions or criteria using the GUI displayed on his/her local computing device for receiving alerts from the data management system, such as by instructing the data management system to transmit an alert to the user's device when a given operating parameter exceeds a specified operating threshold. In such instance, when the operating parameter exceeds the user-defined threshold, an alert may be automatically transmitted to the user's device to indicate that the parameter has exceeded the threshold. The user may then take appropriate action, if necessary, to ensure the safe and efficient operation of the work rig, such as by adjusting the operational settings and/or limits for the work rig via his/her local computing device and/or by performing any other suitable action.

These and other features, aspects and advantages of the present invention will become better understood with reference to the following description and appended claims. The accompanying drawings, which are incorporated in and constitute a part of this specification, illustrate embodiments of the invention and together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a block diagram of one embodiment of a system for providing wireless communications to and from an onboard computer-based system of a work rig in accordance with aspects of the present subject matter;

FIG. 2 illustrates a simplified block diagram of the system shown in FIG. 1, particularly illustrating an example of the wireless connection provided between the onboard computer-based system and a local computing device as well as the ability of the local computing device to communicate with other computing devices outside the wireless transmission range of the onboard system;

FIG. 3 illustrates a flow diagram of one embodiment of a method for providing wireless communications to and from an onboard computer-based system of a work rig in accordance with aspects of the present subject matter, particularly illustrating an algorithm adapted to allow a local computing device to interface with the onboard computer-based system for accessing data stored on the onboard system;

FIG. 4 illustrates a flow diagram of another embodiment of a method for providing wireless communications to and from an onboard computer-based system of a work rig in accordance with aspects of the present subject matter, particularly illustrating an algorithm adapted to allow a local computing device to interface with the onboard computer-based system for wirelessly controlling aspects of the operation of the work rig;

FIG. 5 illustrates a flow diagram of a further embodiment of a method 400 for providing wireless communications to and from an onboard computer-based system of a work rig in accordance with aspects of the present subject matter, particularly illustrating an algorithm adapted to allow a local computing device to interface with the onboard computer-based system for setting up automatic alerts to be transmitted wirelessly from the onboard system to the local device; and

FIG. 6 illustrates a screenshot of an example graphical user interface that may be utilized in accordance with aspects of the present subject matter to present rig-related data and other information to the user of a local computing device.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

It should be appreciated that the present subject matter refers to sensors, processors, database servers, logic, memory, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, methods discussed herein may be implemented using a single server or multiple servers working in combination. Similarly, databases and logic for manipulating the databases may be implemented on a single system or distributed across multiple systems sequentially or in parallel. Data transferred between components may travel directly or indirectly. For example, if a first device accesses a file or data from a second device, the access may involve one or more intermediary devices, proxies, and the like. The actual file or data may move between the components, or one device may provide a pointer or metafile that the other device uses to access the actual data from a still further device.

It should also be appreciated that the various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality complementary or unrelated to the present subject matter, as well. For instance, one or more computing devices may be adapted to provide desired functionality by accessing logic or software instructions rendered in a computer-readable form. When software is used, any suitable programming, scripting, or other type of language or combinations of languages may be used to implement the teachings contained herein. However, software need not be used exclusively, or at all. For example, some embodiments of the systems and methods set forth herein may also be implemented by hard-wired logic or other circuitry, including, but not limited to application-specific circuits. Of course, combinations of computer-executed software and hard-wired logic or other circuitry may be suitable, as well.

Additionally, embodiments of the systems and methods disclosed herein may be executed by one or more suitable computing devices. Such system(s) may comprise one or more computing devices adapted to perform one or more embodiments of the methods disclosed herein. As noted above, such devices may access one or more computer-readable media that embody computer-readable instructions which, when executed by at least one computer, cause the computer(s) to implement one or more embodiments of the methods of the present subject matter. Additionally or alternately, the computing device(s) may comprise circuitry that renders the device(s) operative to implement one or more of the methods of the present subject matter. Furthermore, components of the presently-disclosed technology may be implemented using one or more computer-readable media. Any suitable computer-readable medium or media may be used to implement or practice the presently-disclosed subject matter, including, but not limited to, diskettes, drives, and other magnetic-based storage media, optical storage media, including disks (including CD-ROMs, DVD-ROMs, and variants thereof), flash, RAM, ROM, and other memory devices, and the like.

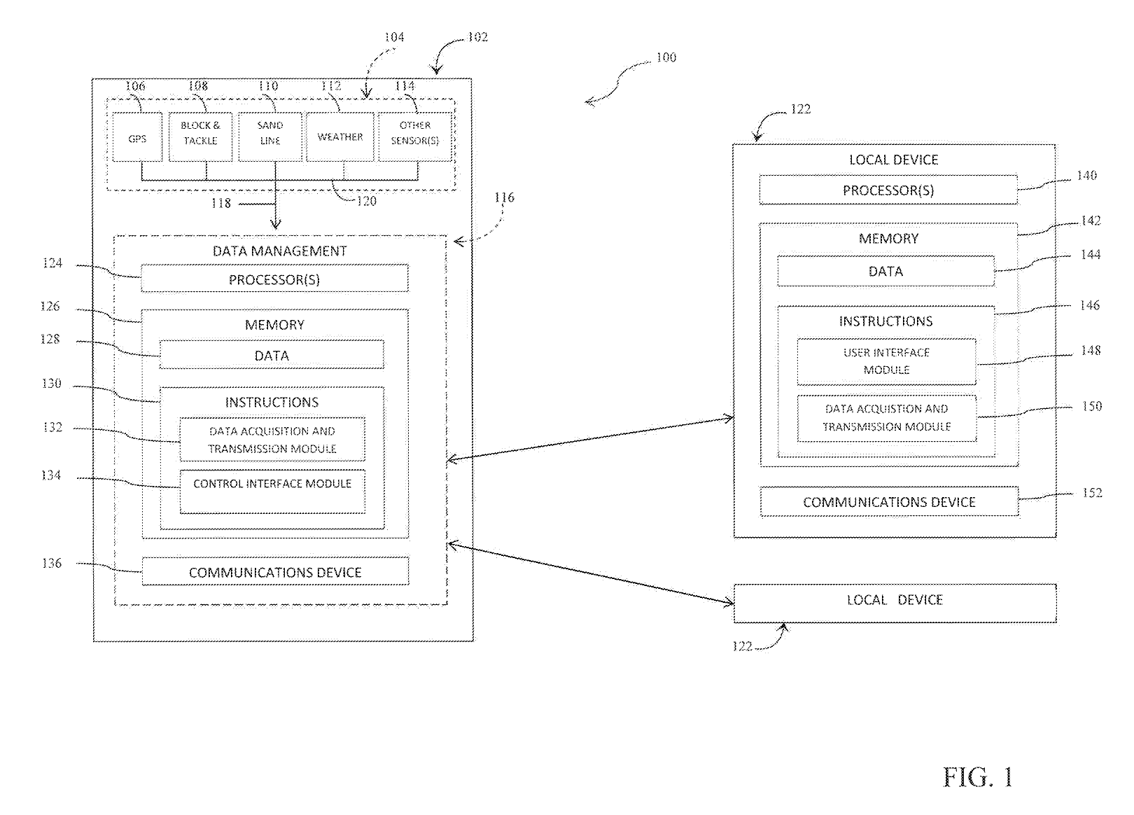

Referring now to FIG. 1, a block diagram of one embodiment of a system 100 for providing wireless communications to and from an onboard computer-based system of a work rig is illustrated in accordance with aspects of the present subject matter. As indicated above, the present subject matter may generally be applicable to any suitable work rig, such as a drilling rig, a well work-over rig and/or the like. However, for purposes of describing the example system 100 shown in FIG. 1, the work rig will be described as a drilling rig 102. It should be appreciated that, although the communications herein will generally be described with reference to wireless communications to and from the onboard computer-based system, the communications may, in alternative embodiments, correspond to communications transmitted via a wired connection.

As shown, the drilling rig 102 may include a plurality of sensors 104 configured to monitor various parameters associated with the operation of the rig 102, including any suitable parameters associated with the environment of and around the drilling rig 102. For example, suitable rig sensors 104 may include, but are not limited to, a GPS sensor 106, a block and tackle sensor 108, a sand line sensor 110, a weather sensor 112, and any other suitable sensor(s) 114, such as any user-selected sensor(s) for monitoring any particular operating parameter(s) associated with the drilling rig 102. As shown in FIG. 1, the various sensors 104 may be communicatively coupled to a data management system 116 via a suitable communications link 118. As such, each sensor 104 may be configured to transmit a specific type of data 120 associated with the drilling rig 102 to the data management system 116 via the communications link 118. For instance, based on the type of sensors used, the data 120 may include information related to rig safety, equipment maintenance requirements, rig operating parameters and other data of interest to rig management personnel. It should be appreciated that the communications link 118 may include one or more wired, wireless, or other suitable communication links known to one of ordinary skill in the art for transferring data between components.

In general, the data management system 116 may correspond to a computer-based system positioned on or within the work rig 102 that is configured to acquire and store the data 120 transmitted from the various sensors 104 as well as to wirelessly communicate with one or more local computing devices 122 located within the vicinity of the drilling rig 102. As shown in FIG. 1, the data management system 116 may include one or more processors 124 and associated memory 126 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 126 may generally comprise memory element(s) including, but not limited to, computer readable medium (e.g., random access memory (RAM)), computer readable non-volatile medium a flash (e.g., memory), a floppy disk, a compact disc-read only memory (CD-ROM), a magneto-optical disk (MOD), a digital versatile disc (DVD) and/or other suitable memory elements. Such memory 126 may generally be configured to store information accessible to the processor(s) 124, including data 128 that can be retrieved, manipulated, created and/or stored by the processor(s) 124 and instructions 130 that can be executed by the processor(s) 124.

In several embodiments, the data 128 may be stored in one or more databases. For example, the memory 126 may include a sensor database (not shown) including the sensor data 120 (e.g., in the form of sensor measurements and/or signals) collected from the various sensors 104 associated with the drilling rig 102. In addition, the memory 126 may include any other suitable database(s) for storing information or data related to the drilling rig 102, such as a database for storing operational settings and/or limits for the drilling rig 102 (including user-defined settings and/or limits), a database for storing alert data associated with automatic notifications or alerts to be provided by the data management system 116 and/or a database for storing other data or information associated with performing any of the methods described herein.

Additionally, in several embodiments, the instructions 130 stored within the memory 126 of the data management system 116 may be executed by the processor(s) 124 to implement a data acquisition and transmission module 132 (hereinafter referred to as the DAQ module 132). In general, the DAQ module 132 may be configured to receive and store the data transmitted from the sensor(s) 104 and/or the data transmitted from any other suitable device(s) communicatively coupled to the data management system 116. For example, the DAQ module 132 may be configured to format the data 120 received from the sensor(s) 104 and store such data within the memory 26 of the data management system 116. In addition, the DAQ module 132 may also be configured to wirelessly transmit data stored within the memory 126 of the data management system 116 to one or more local device(s) 122 positioned proximal to the drilling rig 102 to allow such data to be displayed to the user(s) of the device(s) 122. For instance, data related to the monitored operating parameters of the drilling rig 102 may be wirelessly transmitted to the local device(s) 122 for subsequent presentation to the user(s) via a suitable graphical user interface (GUI) displayed by the user's device. In addition, the DAQ module 132 may also be configured to transmit notifications or alerts to the local device(s) 122. For example, as will be described below, a user may request that automatic alerts be transmitted to his/her local device 122 when certain operating events occur (e.g., when an operating parameter exceeds a pre-defined limit). In such instance, the DAQ module 132 may be configured to automatically transmit an alert (e.g., a text or email alert) to the user's device 122 to indicate that a specific event(s) has occurred.

Moreover, in several embodiments, the instructions 130 stored within the memory 126 of the data management system 116 may be executed by the processor(s) 124 to implement a control interface module 134. In general, the control interface module 134 may be configured to receive data requests, control commands and/or the like from the local device(s) 122 configured to communicate wirelessly with the data management system 116. For example, as will be described in greater detail below, a user may utilize his/her local device 122 to transmit instructions to the data management system 116 for adjusting the operational settings and/or limits associated with one or more of the monitored operating parameters for the drilling rig 102. In such instance, the instructions implemented by the data management system 116 may allow for the control interface module 134 to adjust the operational settings and/or limits based on the user's instructions. For example, the control interface module 134 may be configured to directly interface with the control system (not shown) of the drilling rig 102 for adjusting the specified settings and/or limits.

Additionally, as shown in FIG. 1, the data management system 116 may also include or may be communicatively coupled to a communications device 136. In general, the communications device 136 may correspond to any suitable communications equipment/component(s) that facilitates communications between the data management system 116 and one or more separate devices, such as the local device(s) 122, via any suitable communications protocol (including wired and/or wireless communications protocols). In a particular embodiment, the communications device 136 may correspond to wireless communications equipment/component(s) (e.g., a wireless router, antenna, transmitter, receiver and/or the like) that facilitates wireless communications via any suitable wireless communications protocol. For instance, suitable wireless communications protocols may include, but are not limited to, WiFi, Bluetooth, Near-Field Communication, M-Bus, ZigBee, and/or the like.

As indicated above, the data management system 116 may be housed on or within the drilling rig 102. As such, the various component(s) of the data management system 116 may, for example, be contained within a protective housing (not shown) to insulate such components from the surrounding environment. As should be readily appreciated, the degree and type of protection the housing is required to provide will generally be dictated by the environment in which the data management system 116 is used (e.g., weather proof, hermetically sealed, etc.).

As shown in FIG. 1, the disclosed system 100 may also include one or more local devices 122 configured to communicate with the onboard data management system 116. In general, each local device 122 may correspond to any suitable computing device or other processor-based device. However, in several embodiments, each local device 122 may correspond to a portable/mobile computing device, such as a smartphone, tablet, laptop and/or the like, that is configured to be carried or transported by a user within the local vicinity of the drilling rig 102.

Similar to the data management system 116, each local device 122 may generally include one or more processors 140 and associated memory 142 configured to perform a variety of computer-implemented functions (e.g., performing the methods, steps, calculations and the like disclosed herein). The memory 142 may generally be configured to store information accessible to the processor(s) 140, including data 144 that can be retrieved, manipulated, created and/or stored by the processor(s) 140 and instructions 146 that can be executed by the processor(s) 140.

In several embodiments, the data 144 may be stored in one or more databases. For example, the memory 142 may include a database (not shown) for storing data transmitted to the local device 122 from the data management system 116 (e.g., data associated with the information collected by the sensors 104). In addition, the memory 142 may include any other suitable database(s) for storing information or data, such as a database for storing data or information associated with performing any of the methods described herein.

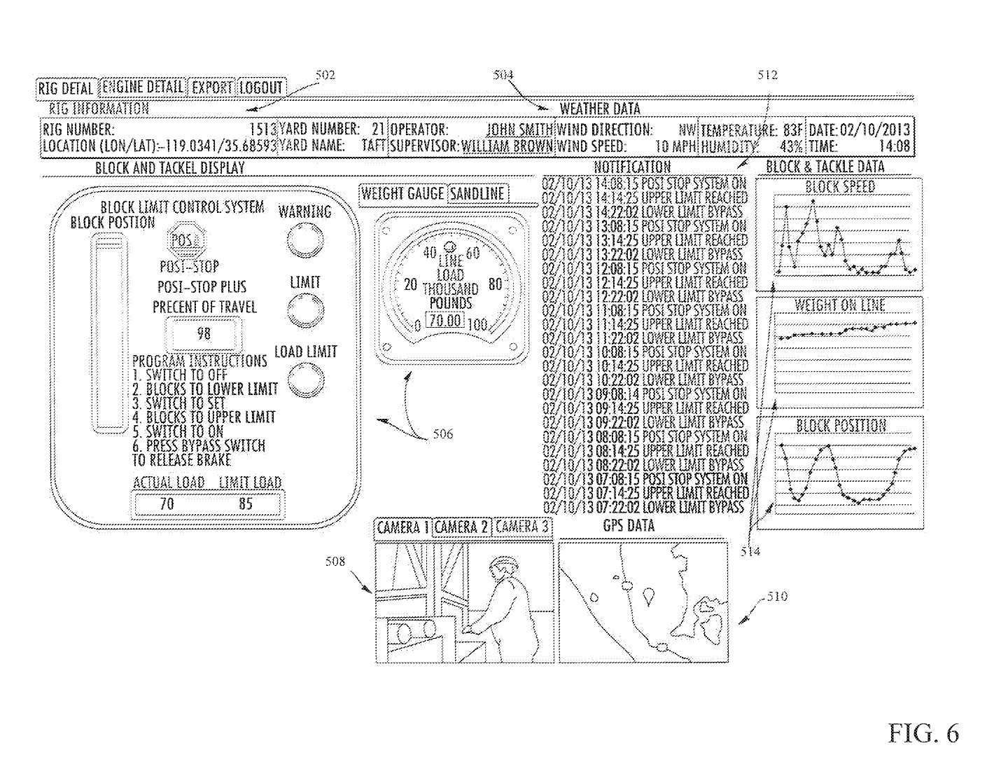

As shown in FIG. 1, in one embodiment, the instructions 146 stored within the memory 142 of each local device 122 may be executed by the processor(s) 140 to implement a user interface module 148. In general, the user interface module 148 may be configured to allow a user of the local device 122 to view data transmitted from the data management system 116 or otherwise interface with the data management system 116. For example, the user interface module 148 may be configured to provide a suitable GUl for displaying data and/or alerts transmitted to the local device 122 from the data management system 116. An example of a suitable GUI 500 that may be presented to the user of the local device 122 is shown in FIG. 6.

In addition, the user interface module 148 may also be configured to provide suitable interface elements (e.g., as part of the presented GUI) for allowing a user of the local device 122 to input instructions, data, control commands and/or the like to be transmitted from the local device 122 to the data management system 116. For example, as indicated above, a user may utilize his/her local device 122 to transmit instructions to the data management system 116 for adjusting the operational settings and/or limits associated with one or more of the monitored operating parameters for the drilling rig 102. In such instance, the user interface module 148 may be configured to provide the user with suitable interface elements (e.g., text entry boxes, drop-down menus, etc.) for inputting such instructions into his/her device 122. The instructions may then be transmitted to the data management system 116 for storage and/or further processing.

Moreover, as shown in FIG. 1, the instructions 146 stored within the memory 142 of each local device 122 may also be executed by the processor(s) 140 to implement a local data acquisition and transmission module 150 (hereinafter referred to as the local DAQ module 150). In general, the local DAQ module 150 may be configured to communicate with the data management system 116 for obtaining access to the data stored within the data management system 116. For instance, the local DAQ module 150 may be configured to transmit suitable data requests for gaining access to the data stored on the data management system 116 in a manner that allows such data to be presented on the GUI displayed to the user. In such instance, upon receipt of the data request from the local device 122, the data management system 116 may be configured to serve the requested data to the local device 122 for subsequent display to the user of the device 122. Alternatively, the local DAQ module 150 may be configured to transmit suitable data requests for gaining access to the data stored on the data management system 116 in order to enable such data to be downloaded onto the local device 122. In such instance, upon gaining access to the data, the local DAQ module 150 may be configured to download the data from the data management system 116 and store such data within the memory 142 of the local device 122.

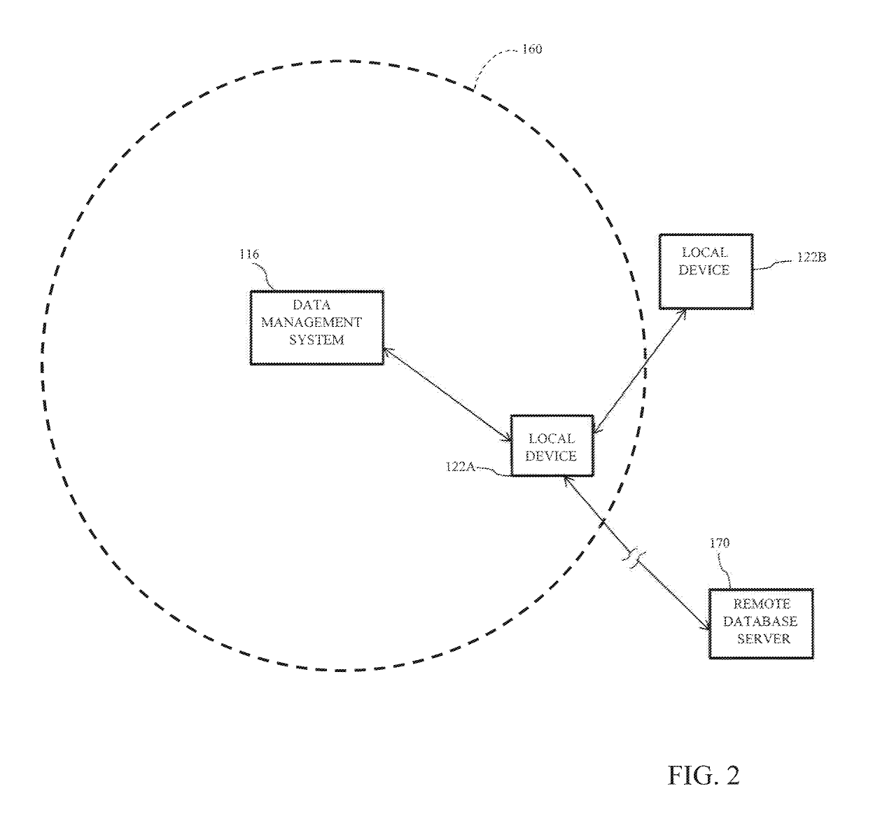

In addition to transmitting data/information to the data management system 116, it should be appreciated that the local DAQ module 150 may also be configured to transmit the data/information stored on the local device 122 to one or more separate computing device(s). For instance, as will be described below with reference to FIG. 2, the local device 122 may be configured to transmit the data/information to other computing devices positioned outside the wireless transmission range of the data management system 116, including another local computing devices and/or a database server located remote to the drilling rig 102.

As shown in FIG. 1, each local device 122 may also include or may be communicatively coupled to a communications device 152. In general, the communications device 152 may correspond to any suitable communications equipment/component(s) that facilitates communications between the local device 122 and one or more separate devices, such as the data management system 116, via any suitable communications protocol (e.g., any suitable wired and/or wireless communications protocol). In a particular embodiment, the communications device 152 may correspond to wireless communications equipment/component(s) (e.g., a wireless router, antenna, transmitter, receiver and/or the like) that facilitates wireless communications via any suitable wireless communications protocol. For instance, as indicated above, suitable wireless communications protocols may include, but are not limited to, WiFi, Bluetooth, Near-Field Communication, M-Bus, ZigBee, and/or the like.

It should be appreciated that, as used herein, the term “module” generally refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium.

Referring now to FIG. 2, a simplified schematic diagram of the system 100 described above with reference to FIG. 1 is illustrated in accordance with aspects of the present subject matter, particularly illustrating an example of the wireless connection provided between the data management system 116 and the local device(s) 122. As indicated above, the data management system 116 may be configured to communicate data wirelessly via its communications device 136. In this regard, the communications device 136 may generally have a given wireless transmission range 160 (e.g., as indicated by the dashed circle in FIG. 2) over which data can be transmitted from the data management system 116 to a separate computing device, with the particular length of the transmission range 160 depending on the specific wireless communications protocol being utilized by the communications device 136 to transmit the data.

As shown in FIG. 2, any local devices within the transmission range 160 of the data management system 116 (e.g., a first local device 122A) may be configured to directly communicate with the data management system 116 via the wireless connection provided between their respective communication devices 136, 152. As such, data (e.g., sensor data) and alerts may be transmitted from the data management system 116 to the local device(s) 122A for subsequent display to the user(s) of such device(s) 122A. However, as shown in the illustrated embodiment, separate computing devices positioned outside the transmission range 160 of the data management system 116 may not be capable of directly communicating with the data management system 116 via a wireless connection.

To address this issue, each local device 122A within the transmission range 160 of the data management system 116 may be configured to download and locally store data from the data management system 116 and subsequently transmit such data to any other authorized computing device(s) (e.g., via its local DAQ module 150). For instance, a local device that has acquired data from the data management system 116 may be configured to connect to any suitable network (e.g., a cellular network, wide area network, local area network, etc.) via its communications device 152 to allow the data to be transmitted to one or more separate computing devices. Thus, as shown in FIG. 2, the first local device 122A may be configured to transmit data received from the data management system 116 to a second local device 122B positioned outside the transmission range 160 of the data management system 116. Additionally, the first local device 122A may also be capable of transmitting such data to a remote database server 170 that is configured to store the data and subsequently provide access to the data using any suitable client-server architecture.

As indicated above, it should be appreciated that, as an alternative embodiment, a wired connection may be provided between the data management system 116 and each local device, such as local device 122A. In such an embodiment, data may be transmitted from the data management system 116 to the local device 122A via the wired connection. Such data may then be transmitted from the local device 122A to any other computing devices via any suitable connection. In another embodiment, data may be transmitted indirectly from the data management system 116 to each local device via a suitable storage medium. For instance, data from the data management system 116 may be initially stored onto a portable storage device, such as a CD, DVD, thumb drive and/or the like, and then subsequently downloaded onto the local device 122A from, the storage device. Such data may then be transmitted from the local device 122A to any other devices via any suitable connection.

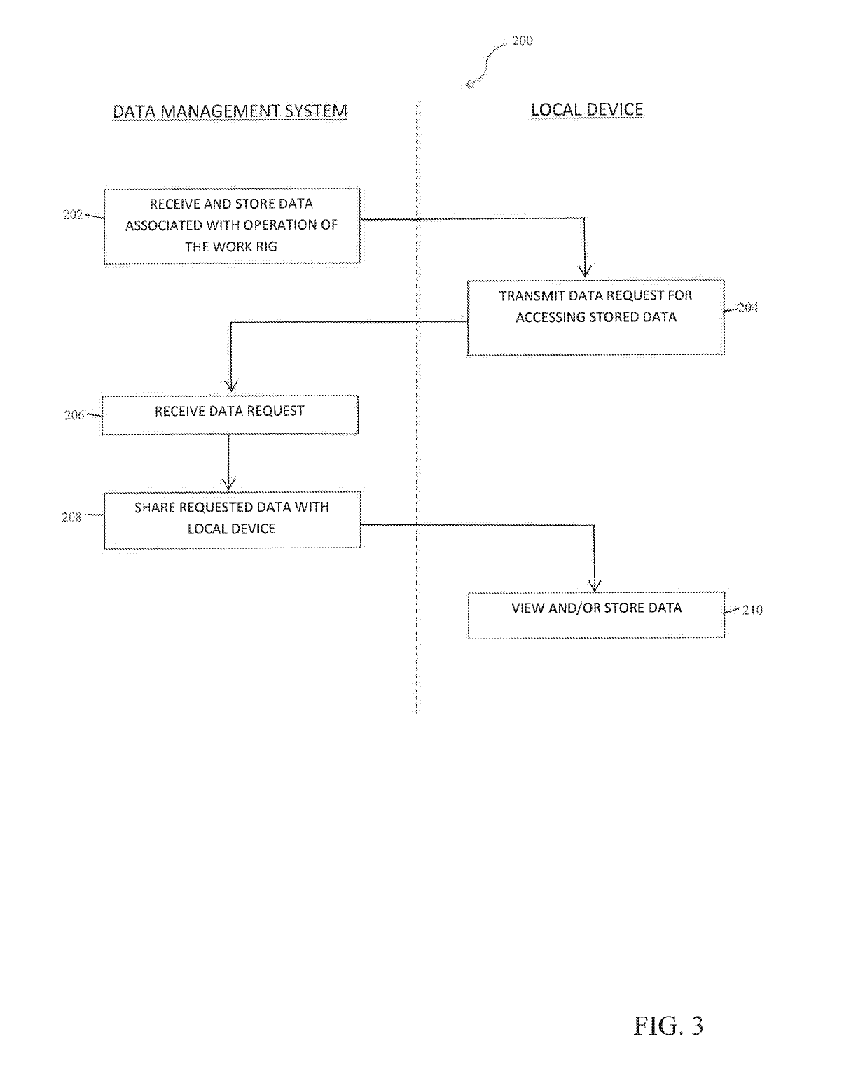

Referring now to FIG. 3, a flow diagram of one embodiment of a method 200 for providing wireless communications to and from an onboard computer-based system of a work rig is illustrated in accordance with aspects of the present subject matter, particularly illustrating an algorithm adapted to allow a local computing device to interface with the onboard computer-based system for accessing data stored on the onboard system. In general, the method 200 will be described herein with reference to the system 100 shown in FIG. 1. However, those of ordinary skill in the art, using the disclosures provided herein, should readily appreciate that the disclosed methods may be utilized with any other suitable system for providing wireless communications between the onboard computer-based system of a work rig and one or more other separate computing devices.

As shown in FIG. 3, at (202), data may be received by and stored within the data management system 116 that is associated with the operation of the work rig 102. For example, as indicated above, the data management system 116 may be communicatively coupled to a plurality of different sensors 104 configured to monitor various operating parameters for the work rig 102. As such, the sensors 104 may be configured to transmit data associated with the monitored operating parameters to the data management system 116. The data management system 116 may, in turn, store the data within its memory 126.

Additionally, at (204), a data request may be transmitted by a local device 122 positioned within the wireless transmission range 160 of the data management system 116 for accessing all or a portion of the data stored within the data management system 116. For example, as indicated above, each local device 122 may include a local DAQ module 150 that is configured to transmit data requests for viewing and/or downloading the data stored on the data management system 116. As such, upon receiving a suitable input from the user of the local device 122 (e.g., via the user interface module 148), the device 122 may be configured to wireless transmit a request to access the data stored on the data management system 116.

Moreover, at (206), the data request may be received by the data management system 116. Thereafter, at (208), the data management system 116 may be configured to share the requested data with the local device 122 via the wireless connection provided between the data management system 116 and the local device 122. For instance, if the local device 122 has simply requested to view the data, the data management system 116 may be configured to share the data with the local device 122 in a manner that allows the data to be subsequently presented to the user (e.g., within the GUI provided by the user interface module 148). Alternatively, if the local device 122 has requested to download the data, the data management system 116 may be configured to transmit the data to the local device 122 for storage thereon.

Referring still to FIG. 3, at (210), the data shared by the data management system 116 may be viewed and/or stored by the local device 122, For instance, as indicated above, the user interface module 148 of the local device 122 may be configured to provide a suitable GUI for displaying the data shared by the data management system 116. Specifically, as will be described below with reference to FIG. 6, the GUI may, for example, be in the form of a dashboard that allows the user to view various different types of operating data related to the work rig 102 on a single interface page.

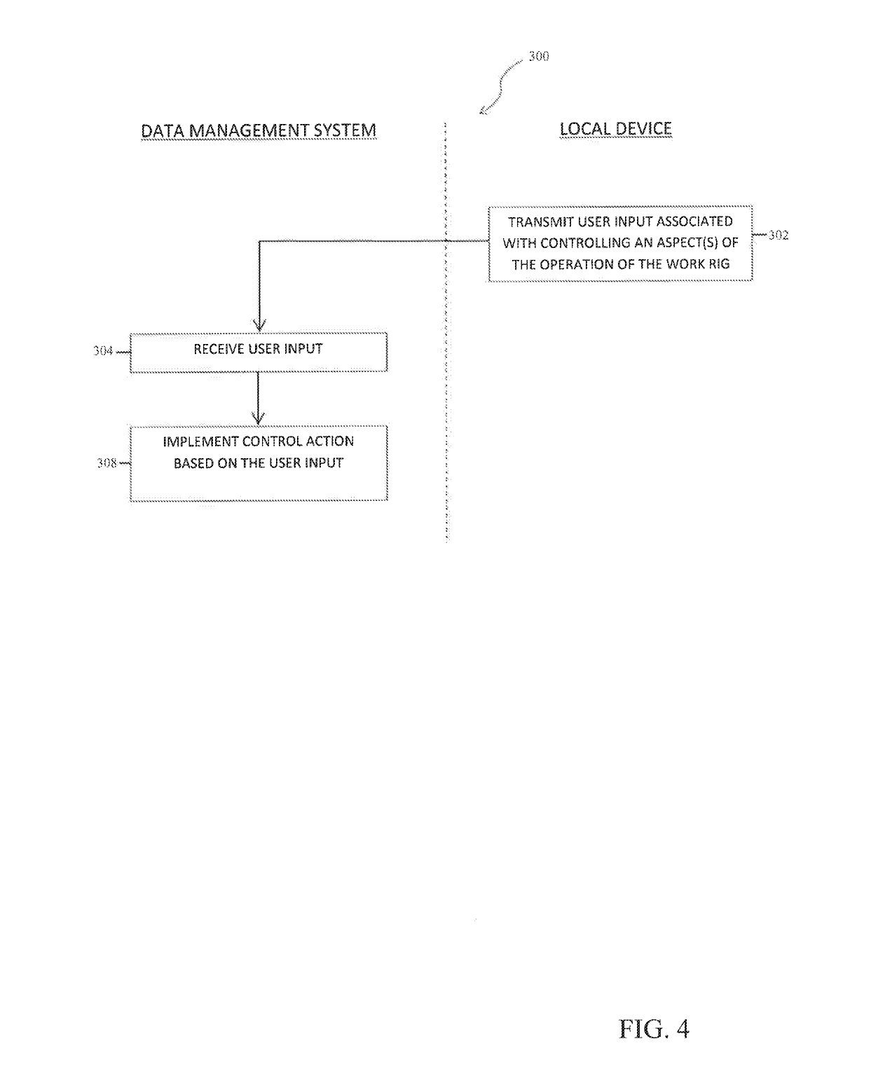

Referring now to FIG. 4, a flow diagram of another embodiment of a method 300 for providing wireless communications to and from an onboard computer-based system of a work rig is illustrated in accordance with aspects of the present subject matter, particularly illustrating an algorithm adapted to allow a local computing device to interface with the onboard computer-based system for wirelessly controlling aspects of the operation of the work rig. In general, the method 300 will be described herein with reference to the system 100 shown in FIG. 1. However, those of ordinary skill in the art, using the disclosures provided herein, should readily appreciate that the disclosed methods may be utilized with any other suitable system to allow one or more local computing device to wirelessly control aspects of the operation of a work rig.

As shown in FIG. 4, at (302), a user input is transmitted from the local device 122 to the data management system 116 that is associated with controlling one or more aspects of the operation of the work rig 102. For instance, as indicated above, the local device 122 may include a user interface module 148 that provides suitable interface elements (e.g., as a part of the GUI presented to the user) for allowing the user to provide inputs related to adjusting and/or otherwise controlling various aspects of the operation of the work rig 102. For example, the user may be allowed to transmit user inputs associated with adjusting the settings and/or operational limits associated with one or more of the monitored operating parameters of the work rig 102, such as by requesting that the maximum limit for a given operating parameter be shifted up or down. In addition, the user may be allowed to transmit user inputs associated with requests for calibrating one or more of the components of the work rig 102.

Moreover, as shown in FIG. 4, at (304), the user input is received by the data management system 116. Thereafter, at (306), the data management system 116 may be configured to implement a suitable control action in response to the user input. For example, if the user input is associated with adjusting a setting(s) and/or operational limit(s) for one or more of the rig's operating parameters, the data management system 116 may be configured to directly adjust the setting(s)/limit(s) or transmit a suitable control signal to a separate component(s) of the work rig 102 (e.g., a separate control system of the work rig 102) instructing such component(s) to adjust the setting(s)/limit(s) in accordance with the user input transmitted from the local device 122. Similarly, if the user input is associated with performing a calibration of one or more of the components of the work rig 102, the data management system 116 may be configured to implement the requested calibration or transmit a suitable control signal(s) instructing that the calibration to be performed.

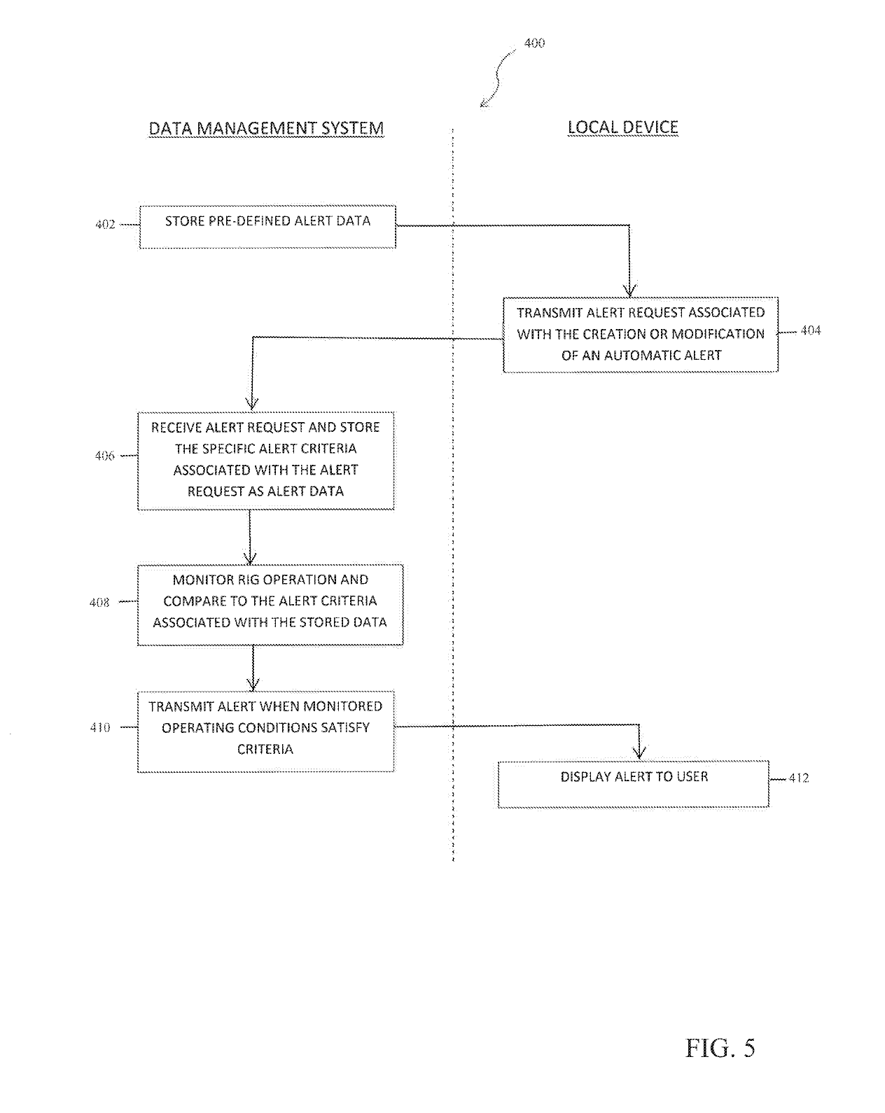

Referring now to FIG. 5, a flow diagram of a further embodiment of a method 400 for providing wireless communications to and from an onboard computer-based system of a work rig is illustrated in accordance with aspects of the present subject matter, particularly illustrating an algorithm adapted to allow a local computing device to interface with the onboard computer-based system for setting up automatic alerts to be transmitted wirelessly from the onboard system to the local device. In general, the method 400 will be described herein with reference to the syse 100 shown in FIG. 1. However, those of ordinary skill in the art, using the disclosures provided herein, should readily appreciate that the disclosed methods may be utilized with any other suitable system for allowing wireless alerts to be created by and transmitted one or more local computing devices.

As shown in FIG. 5, at (402), any previously received or pre-defined alert data may be stored within the data management system 116. For instance, as indicated above, the memory 126 of the data management system 116 may include one or more databases for storing any type of data associated with the operation, maintenance and/or monitoring of the work rig 102, including data associated with automatic notifications or alerts to be provided to users of the local devices 122 positioned within the wireless transmission range 160 of the data management system 116. Thus, for example, a plurality of separate alert files may be stored within the memory 126 of the data management system 116, with each alert file being associated with a different automatic alert to be transmitted to one or more local devices 122 upon the occurrence of a specified rig event and/or upon the operating conditions of the work rig 102 satisfying any pre-defined alert conditions or criteria. For instance, one or more alert files may be stored within the data management system 116 that are associated with providing an automatic alert when one or more of the monitored operating parameters for the work rig 102 exceed a pre-defined operational threshold(s) or limit(s).

It should be appreciated that the alert data stored within the data management system 116 may be associated with pre-programmed alerts or user-defined alerts. For instance, a user of a local device 122 may be configured to set-up specific user-defined alert(s) that will be automatically transmitted to the user's device when the operating conditions of the work rig 102 match the user-defined criteria associated with the alert(s). Specifically, as shown in FIG. 5, at (404), an alert request may transmitted from the local device 122 to the data management system 16 that is associated with creating a new alert file within the data management system 116 or modifying a pre-existing alert file within the data management system 116. For instance, as indicated above, the local device 112 may include a user interface module 148 that provides suitable interface elements (e.g., as a part of the GUI presented to the user) for allowing, the user to provide inputs associated with alert-specific, user-defined criteria. As indicated above, such user-defined criteria may correspond to, for example, specific settings, limits and/or values associated with one or more of the monitored operating parameters for the work rig 102. For instance, the user may indicate that it is desired to receive an alert when the sensor measurement provided from the block and tackle sensor 108 exceeds a given threshold.

Referring still to FIG. 5, at (406), the alert request (including any user-defined criteria associated with the request) may be received by and stored within the data management system as alert data. For instance, the alert data associated with the newly received alert request may be stored within the same database(s) as any other alert data previously received by the data management system 116. Thereafter, at (408), the operation of the work rig 102, may be monitored and compared to the specific alert criteria associated with the alert data stored within the data management system 116. For example, as indicated above, the data management system 116 may be communicatively coupled to various sensors 104 for monitoring the operation of the work rig 102. As such, the data management system 116 may be configured to compare the data provided from the sensors 104 with the pre-defined alert criteria. If the sensor data indicates that the current operating conditions of the work rig 102 satisfy the pre-defined criteria associated with a given alert file, the data management system 116 may then, at (410), automatically and wirelessly transmit an associated alert to the local device 122 indicating that the pre-defined criteria have been satisfied. As indicated above, the alert may generally take any suitable form, such as an email alert or a text alert.

At (412), the alert may be received by the local device 122 and subsequently displayed to the user on a suitable interface presented on the device 122. The user of the local device 122 may then take appropriate action, if necessary, to adjust the operation of the work rig 102 based on the subject matter of the alert.

As indicated above, FIG. 6 illustrates an example screenshot of a suitable GUI 500 that may be used to present rig-related data and information to a user of a local device 122. As shown in FIG. 6, the GUI 500 is configured similar to a dashboard-type display and, thus, may provide various different types of information for presentation to the user, For example, the GUI 500 may display “RIG INFORMATION” 502 for identifying the particular drilling rig 102 for which the data is being viewed and “WEATHER DATA” 504 local to that particular drilling rig 102. In addition, the GUI 500 may display real time or near real time equipment readings 506, video streams 508, and/or GPS data 510. Moreover, the GUI 500 may also display a record of previous notifications or alerts 512 transmitted for the drilling rig 102 and/or graphs of various selected operating parameters over time 514 to enable the customer to promptly respond to previous alerts 512 and/or anticipate and avoid future alerts 512.

It should be appreciated that the GUI 500 shown in FIG. 6 is simply provided as one example of a suitable interface that may be utilized in accordance with aspects of the present subject matter. One of ordinary skill in the art should appreciate that various other GUIs may be provided in order to display rig-related data and/or information to a user of a local device 122.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for communicating with a drill rig, comprising:
a data management system on the drill rig, wherein said data management system is configured to receive data reflective of an operating parameter of the drill rig;
a communications device operably coupled to said data management system and configured to transmit said data reflective of the operating parameter;
a local computing device configured to receive from said communications device said data reflective of the operating parameter, wherein said local computing device is a smart phone or a tablet; and
a graphical user interface on said local computing device configured to display said data reflective of the operating parameter.

2. The system as in claim 1, wherein said data reflective of an operating parameter of the drill rig comprises at least one of a temperature, a pressure, a speed, a depth, a weight, or a volume associated with equipment on the drill rig.

3. The system as in claim 1, wherein said data reflective of an operating parameter of the drill rig comprises at least one of a weather condition, a weather forecast, a location, or an attitude associated with the drill rig.

4. The system as in claim 1, wherein said communications device is configured to transmit to said local computing device a notification that the operating parameter exceeds a predetermined limit.

5. The system as in claim 1, wherein said local computing device is configured to transmit to said communications device an operating limit for the operating parameter.

6. The system as in claim 1, wherein said local computing device is configured to transmit to said communications device an instruction to perform a calibration of equipment on the drill rig.

7. The system as in claim 1, wherein said local computing device is configured to transmit to said communications device an instruction to adjust an operational setting on the drill rig.

8. A method for communicating with a drill rig, comprising:
receiving in a data management system on the drill rig data reflective of an operating parameter of the drill rig;
transmitting said data reflective of the operating parameter to a local computing device, wherein said local computing device is a smart phone or a tablet; and
displaying said data reflective of the operating parameter on said local computing device.

9. The method as in claim 8, further comprising monitoring at least one of a temperature, a pressure, a speed, a depth, a weight, or a volume associated with equipment on the drill rig.

10. The method as in claim 8, further comprising monitoring at least one of a weather condition, a weather forecast, a location, or an attitude associated with the drill rig.

11. The method as in claim 8, further comprising transmitting to said local computing device a notification that the operating parameter exceeds a pre-determined limit.

12. The method as in claim 8, further comprising transmitting from said local computing device to said data management system an operating limit for the operating parameter.

13. The method as in claim 8, further comprising transmitting from said local computing device to said data management system an instruction to perform a calibration of equipment on the drill rig.

14. The method as in claim 8, further comprising transmitting from said local computing device to said data management system an instruction to adjust an operational setting on the drill rig.

15. A method for communicating with a drill rig, comprising:
receiving in a data management system on the drill rig data reflective of an operating parameter of the drill rig;
transmitting from a local computing device to said data management system a request for accessing said data reflective of the operational parameter, wherein said local computing device comprises a smart phone or a tablet;
transmitting from said data management system to said local computing device said data reflective of the operational parameter;
transmitting from said local computing device to said data management system an instruction to control equipment on the drill rig.

16. The method as in claim 15, further comprising transmitting from said local computing device to said data management system an operating limit for the operating parameter.

17. The method as in claim 16, further comprising comparing the operating limit for the operating parameter to said data reflective of the operation parameter.

18. The method as in claim 17, further comprising transmitting from said data management system to said local computing device a notification that said data reflective of the operation parameter exceeds the operating limit for the operating parameter.

19. The method as in claim 15, further comprising transmitting from said local computing device to said data management system an instruction to perform a calibration of equipment on the drill rig.

20. The method as in claim 15, further comprising transmitting from said local computing device to said data management system an instruction to adjust an operational setting on the drill rig.
